(19) United States
(12) Patent Application Publication
(10) Pub. No.: US 2008/0254758 A1
(43) Pub. Date: Oct. 16, 2008

(54) FREQUENCY CONVERTER CIRCUIT AND RECEIVER

(76) Inventor: Takanobu FUJIWARA, Osaka (JP)

Correspondence Address: BIRCH STEWART KOLASCH & BIRCH, PO BOX 747, FALLS CHURCH, VA, 22040-0747, US

(21) Appl. No.: 12/041,443

(22) Filed: Mar. 3, 2008

(30) Foreign Application Priority Data
Apr. 16, 2007 (JP) 2007-107557

(51) Int. Cl. H04B 1/26

(52) U.S. Cl. 455/323

(57) ABSTRACT

A frequency converter circuit includes a frequency conversion section for converting an inputted radio frequency voltage signal to a radio frequency current signal, converting the frequency of the signal to a low frequency current signal, and then outputting the low frequency current signal from an output section thereof; an amplifier including an input section connected to the output section of the frequency conversion section, and an input resistor for providing as an input impedance; and a capacitor wherein one terminal is connected to the input section of the amplifier and the other terminal is AC-grounded. With this structure, the electricity consumption can be reduced without deteriorating the SNR.

This Nonprovisional application claims priority under 35 U.S.C. § 119(a) on Patent Application No. 107557/2007 filed in Japan on Apr. 16, 2007, the entire contents of which are hereby incorporated by reference.

### FIELD OF THE INVENTION

The present invention is related to a frequency converter circuit installed in a wireless communication receiver, particularly a frequency converter circuit suitable for use in a receiver that performs frequency conversion in a direct conversion system or a LOW-IF system.

### BACKGROUND OF THE INVENTION

Conventionally, in a receiver which performs frequency conversion in a direct conversion system or a LOW-IF system, a frequency converter circuit performing the frequency conversion of reception signals is installed. The frequency converter circuit is preferably small in size and with low electricity consumption.

FIG. 11 is a circuit diagram schematically illustrating a conventional frequency converter circuit 1000.

The conventional frequency converter circuit 1000, as illustrated in FIG. 11, includes a voltage-output-type frequency conversion section 1011 including an input section 1001, a transconductor 1002, a switch 1003, and a resistor 1004; a voltage-input-type active filter 1012 including a buffer 1005, a resistor 1006, an operational amplifier 1007, a capacitor 1008, and a resistor 1009; and an output section 1010.

A radio frequency signal inputted to the input section 1001 is converted to a low frequency voltage signal by the frequency conversion section 1011. Then, the buffer 1005 converts the voltage output from the frequency conversion section 1011 in impedance, and outputs the converted voltage to the active filter 1012 being the next stage. After an undesired signal is then removed by the active filter 1012, the voltage output is outputted from the output section 1010.

However, this method has two problems as described below.

The first problem is that the buffer 1005 consumes a great amount of the current for impedance conversion. The second problem is that the current consumption required by the operational amplifier 1007 increases in accordance with linearity specification of the active filter 1012.

Consequently, for example, a frequency converter circuit modified such that the first problem is solved is described in Japanese Unexamined Patent Application Publication No. 101353/2000 (Tokukai No. 2000-101353; published on Apr. 7, 2000) (Publication 1).

FIG. 12 is a circuit diagram schematically illustrating the conventional frequency converter circuit 1100 described in Publication 1.

The conventional frequency converter circuit 1100 includes a current-output-type frequency conversion section 1111 including an input section 1001, a transconductor 1002, a switch 1003, and a current source 1104; a current-input-type active filter (current-to-voltage conversion section) including an operational amplifier 1007, a capacitor 1008, and a resistor 1009; and an output section 1010. Thus, by controlling a time constant RC of a feedback circuit (first-order LPF) formed from the capacitor 1008 and the resistor 1009, only the desired signal is amplified.

As such, the current consumption is reduced by connecting the frequency conversion section 1111 and the active filter 1112 in a cascade manner, thereby eliminating the need of a buffer for impedance conversion (the buffer 1005 illustrated in FIG. 11).

In addition, for example, Japanese Unexamined Patent Application Publication No. 339275/2001 (Tokukai No. 2001-339275; published on Dec. 7, 2001) (Publication 2) describes such an art that a current-input-type active filter circuit is provided, thereby eliminating the need of a current-to-voltage converter circuit. This art solves such a problem associated with the conventional voltage-input type active filter circuit that a current-to-voltage converter circuit which causes a larger circuit size and an increase in electricity consumption is required in the case the circuit connected to the previous step of this active filter is a current-output-type.

However, in Publications 1 and 2, the aforementioned second problem has not been solved.

For example, in the conventional frequency converter circuit 1100 described in Publication 1, a high linearity is required from the active filter 1112 in order to avoid the deterioration of a desired signal due to a disturbance wave out of the desired signal band. However, in order to realize a filter with a high linearity, the operational amplifier 1007 being used should have a high specification (band or gain). Therefore, there is the problem such that this will cause the increase in current consumption.

In addition, in Publications 1 and 2, the current-input-type active filter is used. However, Publications 1 and 2 have a such a drawback that the condition (performance) required from the current-input-type active filter is stringent than what is required from a general voltage-input-type active filter.

### SUMMARY OF THE INVENTION

The present invention is made in view of the aforementioned conventional problems, and an object thereof is to provide a frequency converter circuit and a receiver which can reduce the electricity consumption without deteriorating the Signal-to-Noise ratio (hereafter referred as ‘SNR’).

In order to solve the problem, a frequency converter circuit of the present invention comprises a frequency conversion section for converting an inputted radio frequency signal to a low frequency current signal, and outputting the low frequency current signal from an output section thereof; a voltage-input-type amplifier circuit comprising an input section being connected to the output section of the frequency conversion section, and having an input impedance; and a first shunt capacitor wherein one terminal is connected to an input section of the voltage-input-type amplifier circuit, and the other terminal is AC-grounded.

According to the structure, a first-order low-pass filter is formed from the input impedance of the voltage-input-type amplifier circuit and the capacitance of the first shunt capacitor. The first shunt capacitor has one terminal connected to the input section of the voltage-input-type amplifier circuit having the input impedance and the other terminal AC-grounded.

Thus, the undesired radio frequency signal included in the low frequency current signal outputted from the output section of the frequency conversion section is attenuated by the first-order low-pass filter. Accordingly, it is possible to lower the specification of the distortion performance (for example, Out-of-Band IP3) required in the following voltage-input-type amplifier circuit. Consequently, by lowering the specification of the distortion performance of the voltage-input-type amplifier circuit, it is possible to reduce the electricity consumption.

In addition, in the voltage-input-type amplifier circuit, even if the specification of the distortion performance of the voltage-input-type amplifier circuit is lowered, the undesired radio frequency signal is attenuated. Therefore, the output signal intensity of the intermodulation component does not change. Thus, the SNR does not deteriorate. Accordingly, it is possible for the frequency converter circuit of the present invention to reduce the electricity consumption without deteriorating the SNR.

In addition, a receiver of the present invention comprises the aforementioned frequency converter circuit as the frequency converter circuit for converting a frequency of a received radio frequency signal and extracting a desired signal including a low fluency data.

According to the structure, for example, in the direct conversion system or LOW-IF system, it is possible to extract the desired signal including the low frequency data while suppressing the influence of the signal distortion that would be caused by the important undesired disturbance waves. Further, this structure attains low current consumption.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a circuit diagram schematically illustrating one embodiment of a frequency converter circuit of the present invention.

FIG. 2 is a figure illustrating a frequency arrangement of a desired signal and a disturbance wave signal, of the frequency converter circuit.

FIG. 3 is a graph illustrating input and output characteristics of a general amplifier.

FIG. 4 is a graph illustrating input and output characteristics of a current-to-voltage conversion section of the frequency converter circuit.

FIG. 5 is a circuit diagram schematically illustrating another embodiment of the frequency converter circuit of the present invention.

FIG. 6 is a circuit diagram schematically illustrating yet another embodiment of the frequency converter circuit of the present invention.

FIG. 7(a) is a view illustrating an example of a pole arrangement of a complex plane in a fifth-order filter.

FIG. 7(b) is a graph illustrating characteristics of the fifth-order filter.

FIG. 8 is a circuit diagram schematically illustrating still another embodiment of the frequency converter circuit of the present invention.

FIG. 9 is a circuit diagram schematically illustrating yet still another frequency converter circuit of the present invention.

FIG. 10 is a diagram schematically illustrating an embodiment of a receiver of the present invention.

FIG. 11 is a circuit diagram schematically illustrating the conventional frequency converter circuit.

FIG. 12 is a circuit diagram schematically illustrating another conventional frequency converter circuit.

### DESCRIPTION OF THE EMBODIMENTS

### First Embodiment

The following is an explanation of an embodiment of the present invention referring to drawings.

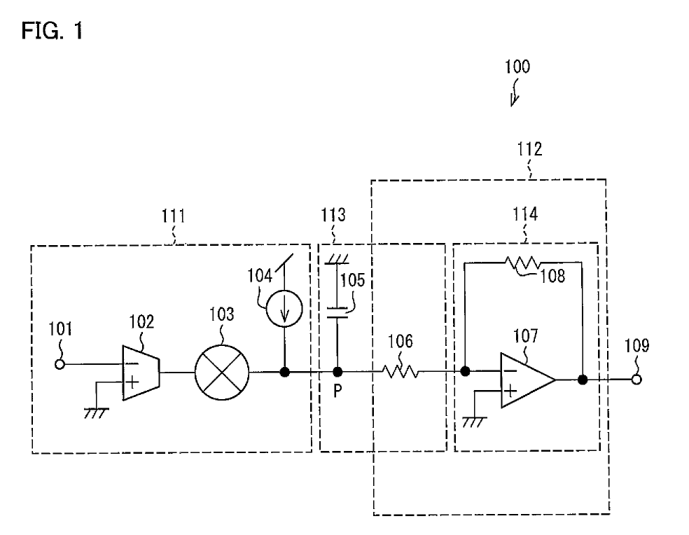

FIG. 1 is a circuit diagram illustrating an exemplary structure of a frequency converter circuit 100.

The frequency converter circuit 100 of the present embodiment is a circuit installed in a receiver which performs frequency conversion, for example in the direct conversion system or the LOW-IF system. The circuit converts the frequency of the received radio frequency signal to a low frequency signal, and outputs a desired signal to a next component, for example a control section, a storing section or a frequency conversion section for converting the signal to a baseband signal.

The frequency converter circuit 100 of the present embodiment includes a frequency conversion section 111, a capacitor 105 (first shunt capacitor), an amplifier circuit 112 (voltage-input-type amplifier circuit), and an output section 109, as illustrated in FIG. 1.

The frequency conversion section 111 converts the radio frequency signal inputted as the voltage signal to the low frequency current signal, and outputs this to the circuit of the following stage. That is to say, the output section of the frequency conversion section 111 is connected to the input section of the amplifier circuit 112. The frequency conversion section 111 includes an input section 101, a transconductor 102, a switch 103, and a current source 104.

The transconductor 102 is an amplifier for converting the inputted voltage signal to the current signal. The transconductor 102 converts, to the current signal, the radio frequency voltage signal inputted via the input section 101. The transconductor 102 has an inverting input terminal connected to the input section 101, a non-inverting input terminal grounded, and an output terminal connected to the switch 103.

The switch 103 converts the frequency of the inputted radio frequency signal to the low frequency signal. In details, the switch 103 performs frequency conversion by receiving a local oscillatory signal outputted from an oscillator not illustrated, together with the radio frequency current signal outputted from the transconductor 102, and thereby generates the low frequency current signal. The output terminal of the switch 103 is connected to the amplifier circuit 112.

The current source 104 is provided as a load of the frequency conversion section 111. The current source 104 has the terminal on the current-providing side connected to the output terminal of the switch 103, and the terminal on the opposite side connected to a power supply. As such, the output terminal of the switch 103 connected with the current source 104 is the output section of the frequency conversion section 111.

The capacitor 105 is a shunt capacitor, and one terminal thereof is connected to a point on a line connecting the output section of the frequency conversion section 111 and the input section of the amplifier circuit 112 (point P), and the other terminal is AC-grounded.

The amplifier circuit 112 converts, to the low frequency voltage signal, the low frequency current signal outputted from the frequency conversion section 111, and outputs the desired low frequency voltage signal to the output section 109. The amplifier circuit 112 has the structure of a voltage-input-type, and includes a resistor 106 and a current-to-voltage conversion section 114 provided with an operational amplifier 107 and a resistor 108.

The input resistor 106 is provided as an input impedance of the amplifier circuit 112. The input resistor 106 has one terminal connected to the frequency conversion section 111, and the other terminal connected to the current-to-voltage conversion section 114. Thus, one terminal of the input resistor 106 is the input section of the amplifier circuit 112.

The operational amplifier 107 has an inverting input terminal connected to the input resistor 106, a non-inverting input terminal grounded, and an output terminal connected to the output section 109. In addition, the resistor 108 is provided in series between the output terminal and the inverting input terminal, whereby negative feedback is attained. By the current-to-voltage conversion section 114 having this operational amplifier 107 and the resistor 108, the current input is converted to the voltage output.

Secondly, the operation of the frequency converter circuit 100 of the present embodiment is described below.

For example, it is assumed that the receiver receives the radio frequency signal via a wireless communication or the like. This radio frequency signal is inputted in the input section 101, and forwarded to the transconductor 102. The radio frequency signal is converted from a voltage signal to a current signal by the transconductor 102. The radio frequency current signal outputted from the transconductor 102 is inputted to the switch 103, which converts the radio frequency current signal to the low frequency current signal.

Accordingly, by having the current source 104 arranged as the load of the frequency conversion section 111, most of the low frequency current signal outputted from the switch 103 is sent to the input resistor 106 of the following amplifier circuit 112.

That is to say, a load impedance Z1 of the frequency conversion section 111 is determined from a capacitance C1 of the capacitor 105 and a resistance R1 of the input resistor 106. The load impedance Z1 is as expressed in formula (1):

Z1=R1//(1/sC1) (1)

where R1//(1s/sC1) is the combined resistance of the input resistor 106 and the capacitor 105 connected in parallel.

Thus, the input resistor 106 functions as both the load resistor of the frequency conversion section 111 and the input resistor of the amplifier circuit 112.

Here, in the frequency converter circuit 100, a first-order low-pass filter (first-order LPF 113) is formed from the capacitor 105 and the input resistor 106 as illustrated in FIG. 1. Thus, the low frequency current signal outputted from the frequency conversion section 111 receives the disturbance wave attenuation effect of a certain value due to the first-order LPF 113.

Therefore, the input current intensity of the current-to-voltage conversion section 114 is weakened by a certain value, compared to the input current intensity of the current-to-voltage conversion section which receives no disturbance wave attenuation effect. The low frequency current signal as such is converted to the low frequency voltage signal by the current-to-voltage conversion section 114.

At this time, as described in detail later, the linearity required by the current-to-voltage conversion section 114 is reduced by the configuration in which the low frequency current signal receives the disturbance wave attenuation effect of a certain value due to the first-order LPF 113. Finally, the low frequency voltage signal is then outputted from the output section 109.

As above, in the frequency converter circuit 100, the received radio frequency signal is converted from a voltage signal to a current signal, and subjected to the frequency conversion to the low frequency current signal. With the configuration in which the load impedance of the frequency conversion section 111 includes the capacitor 105 and the input resistor 106, the low frequency current signal flows to the voltage-input-type amplifier circuit 112. Then, the low frequency current signal is converted back into a voltage signal, and is outputted to the next component.

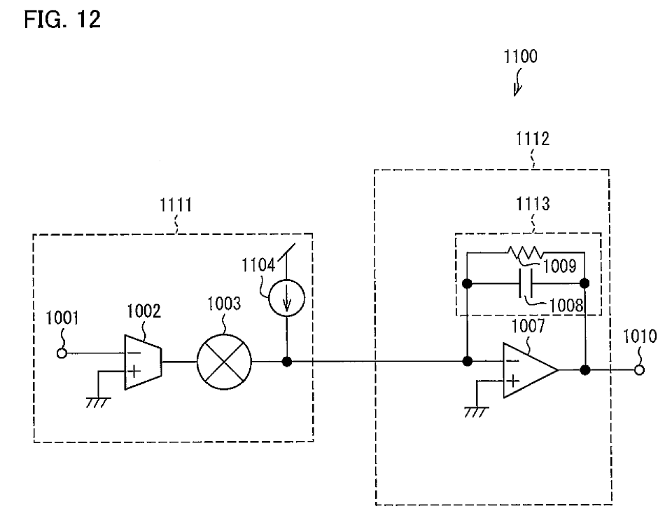

Next, the frequency converter circuit of the present embodiment is quantitatively described on how much the linearity requested from the current-to-voltage conversion section 114 of the amplifier circuit 112 is reduced. The conventional frequency converter circuit 1100 illustrated in FIG. 12 will be discussed to compare with the frequency converter circuit 100 of the present embodiment.

Firstly, in order to fairly evaluate both circuits, three constraint conditions are provided. The explanations of these are as follows.

Condition A) The DC voltage gain from the input to the output is equal for both circuits.
Condition B) The first-order LPF 113 and the first-order LPF 1113 are equal in cutoff frequency.
Condition C) The frequency conversion section 111 and the frequency conversion section 1111 are equal in trans-conductance.

In addition, the DC voltage gains for the frequency converter circuit 100 of the present embodiment and the conventional frequency converter circuit 1100 both are expressed by the following formula (2):

Gain=Gm×Rload (2)

where Gain is the DC voltage gain from the input section 101 to the output section 109, or DC voltage gain from the input section 1001 to the output section 1010, Gm is the trans-conductance [S] of the frequency conversion section 111 or the frequency conversion section 1111, and Rload is the resistance [Ω] of the resistor 108 or the resistor 1009. However, formula (2) assumes that the output resistance of the current source 104 is sufficiently greater than the input resistor 106. In this case, the DC voltage gain of the frequency converter circuit 100 of the present embodiment will be unrelated to the input resistor 106.

Described below are the linear specification of the current-to-voltage conversion section 114 and the current-to-voltage conversion section 1112.

The signal inputted to the current-to-voltage conversion section 114 or the current-to-voltage conversion section 1112 is assumed such that the signal includes the disturbance wave as well as the desired signal including data.

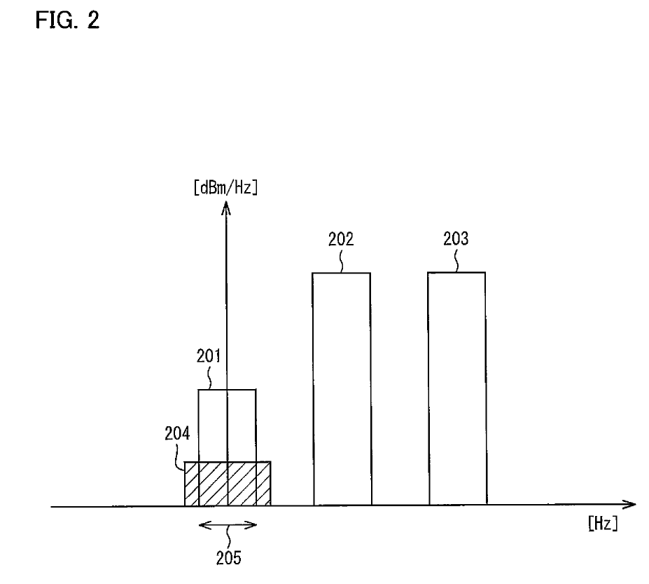

FIG. 2 is a view illustrating the frequency relationship between the assumed desired signal 201, and the disturbance wave signals 202 and 203. The vertical axis shows the output signal electricity [dBm/Hz], and the horizontal axis shows the frequency [Hz].

The signals which will be inputted to the current-to-voltage conversion section 114 or the current-to-voltage conversion section 1112, include a desired signal 201 having the frequency within the desired wave band 205, and a disturbance wave signal 202 or 203 greater than the signal of the desired signal 201 in frequency and output signal electricity.

At this time, if the signal is inputted to the current-to-voltage conversion section 114 or the current-to-voltage conversion section 1112, the disturbance wave signal 202 or 203 will drop within the desired wave band 205 due to the non-linearity of the current-to-voltage conversion section 114 or the current-to-voltage conversion section 1112, and will become an intermodulation component 204.

Therefore, the signal including the intermodulation component 204 is outputted from the output section 109 or the output section 1010. As a result, the SNR of the signal band deteriorates. Thus, the intermodulation component 204 causes the deterioration of the SNR of the signal band. Accordingly, it is necessary to avoid the intermodulation component as much as possible.

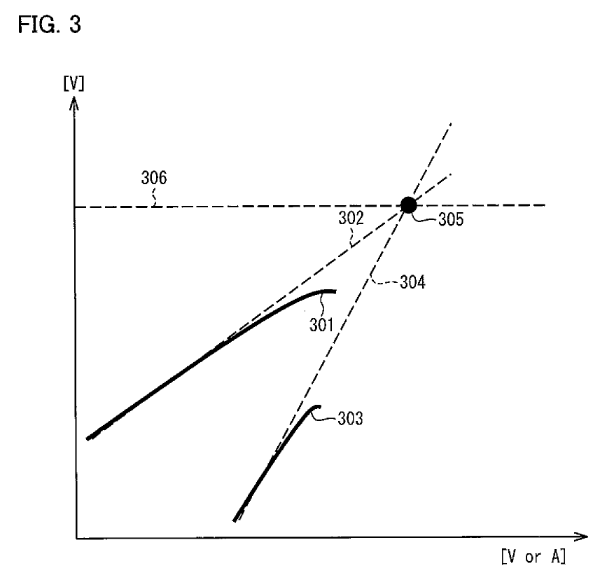

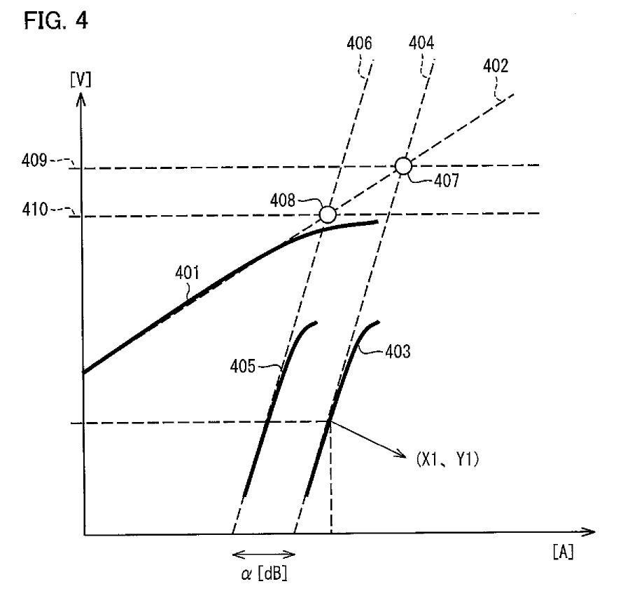

Described below is the input and output characteristics of the current-to-voltage conversion section in which the intermodulation component generates. First the explanation of the input and output characteristics of a general amplifier will be made referring to FIG. 3. Next, the explanation of the input and output characteristic of the current-to-voltage conversion section 114 of the frequency converter circuit 100, and the explanation of the input and output characteristic of the current-to-voltage conversion section 1112 of the conventional frequency converter circuit 1100 will be made referring to FIG. 4.

FIG. 3 is a graph illustrating input and output characteristics of a general amplifier. The vertical axis shows the output signal intensity [V] using a log scale, and the horizontal axis shows the input signal intensity [V or A] (can be voltage or current) using the log scale.

The solid line 301 describes the relationship of the in-band input and output, and the gradient thereof is 1 (dec/dec). The broken line 302 describes a hypothetical linear region of the solid line 301, which assumes that the level further increases without saturation.

The solid line 303 describes the relationship of the input and output of the intermodulation component, and the gradient thereof is 3 (dec/dec). The broken line 304 describes a hypothetical linear region of the solid line 303, which assumes that the level further increases without saturation. The relationship of the input and output of the intermodulation component of the line 303 is, for example, such that the input is the input in the frequency of the disturbance wave signal such as the disturbance wave signal 202 or 203 illustrated in FIG. 2, and the output is the output that drops into the desired wave band such as the intermodulation component 204 as illustrated in FIG. 2.

The intersection 305 of the broken line 302 and the broken line 304 is called an Out-of-Band IP3 (3rd Intercept Point). The Out-of-Band IP3 is the indicator describing the non-linearity of the amplifier. In addition, the readout value 306 of the vertical axis of the Out-of-Band IP3 is called an Out-of-Band OIP3. For example, in a direct conversion receiver, the Out-of-Band OIP3 of a baseband filter section is one of the main factors to determine disturbance wave tolerance. A greater value of the Out-of-Band OIP3 indicates better performance. Thus, the amplifier can be evaluated in its performance by referring to the Out-of-Band OIP3.

FIG. 4 is a graph illustrating input and output characteristics of the current-to-voltage conversion section 114 of the frequency converter circuit 100 of the present embodiment (hereafter referred as ‘the present example’), and the input and output characteristics of the current-to-voltage conversion section 1112 of the conventional frequency converter circuit 1100 (hereafter referred as ‘the conventional example’). The vertical axis shows the output signal intensity [V] using the log scale, and the horizontal axis shows the input current of the current-to-voltage conversion section 114 or the current-to-voltage conversion section 1112 [A] using the log scale.

The solid line 401 describes the relationship between the in-band input and output. Since the resistance value of the resistor 108 and the resistance value of the resistor 1009 are equal from the aforementioned Condition A), the present embodiment and the conventional example have an identical graph line. The broken line 402 describes a hypothetical linear region of the solid line 401, which assumes that the level increases without saturation.

The solid line 403 describes the input and output characteristics of the intermodulation component which is to be required in the conventional example. From this solid line 403, for example, the value of the output signal intensity Y1 [V] of the intermodulation component of when the input current value of the disturbance wave signal is X1 [A] can be figured out. The broken line 404 describes a hypothetical linear region of the solid line 403, which assumes that the level increases without saturation.

Here, it is assumed that an equal disturbance wave signal is inputted from the input section 101 or the input section 1001. Then, in the present example, the signal receiving the disturbance wave attenuation effect of a certain value (α[db]) due to the first-order LPF 113 is inputted, thereby the current input intensity of the present example will weaken by α[db], compared to the current input intensity of the conventional example.

In the case where the intensity of the intermodulation component generated in the current-to-voltage conversion section 114 is made equal to the intensity of the intermodulation component of the conventional example (Y1[V]) due to the input current weaken by a [db], the input and output characteristic of the intermodulation component of the current-to-voltage section 114 will be indicated by the solid line 405. In addition, the broken line 406 describes a hypothetical linear region of the solid line 405, which assumes that the level increases without saturation.

This solid line 405 is equivalent to the solid line 403 being shifted by α[db] horizontally. In other words, even if the intensity characteristic of the intermodulation component deteriorates from the solid line 403 to the solid line 405, the degree of deterioration in the SNR will not change due to the attenuation of the actual input disturbance wave.

As a result, the Out-of-Band IP3 of the conventional example being required is indicated by a intersection 407 of the broken line 402 and the broken line 404, and the Out-of-Band IP3 of the present embodiment being required is indicated by a intersection 408 of the broken line 402 and the broken line 404.

In addition, the readout value 409 of the vertical axis of the intersection 407, and the readout value 410 of the vertical axis of the intersection 408 indicate values of the Out-of-Band OIP3. The difference between these is 1.5α [db]. That is to say, if the suppressing amount of the disturbance waves by the first-order LFP 113 is represented as α, the Out-of-Band OIP3 required by the current-to-voltage conversion section 114 will be reduced by 1.5α.

Thus, if the disturbance wave attenuation effect is provided by the first-order LPF 113, the specification of the Out-of-Band IP3 required by the current-to-voltage conversion section, in other words the linearity decreases, whereby the electricity consumption is possibly reduced. The resistance amount of the disturbance wave is preferably infinite.

As the above, the frequency converter circuit 100 of the present embodiment includes the frequency conversion section 111 wherein the radio frequency voltage signal inputted from the input section 101 is converted to the radio frequency current signal by the transconductor 102, is then converted to the low frequency current signal by the switch 103, and outputs this low frequency current signal from the output section thereof; the amplifier circuit 112 including (i) the input section being connected to the output section of the frequency conversion section 111 and (ii) the input resistor 106 provided as the input impedance; and the capacitor 105 wherein one terminal is connected to point P of the line connecting the output section of the frequency conversion section 111 and the input section of the amplifier circuit 112, and the other terminal is grounded.

In the structure, the first-order LPF 113 is formed from the input impedance of the amplifier circuit 112 and the capacitor 105. This structure attenuates the undesired signal component of a certain value α[db] in the radio frequency signal including the desired signal component and the undesired signal component. Therefore, the amplifier circuit 112 can have a low specification of the distortion performance. Consequently, by lowering the specification of the distortion performance, it is possible to reduce the electricity consumption.

In addition, in the amplifier circuit 112, even if the specification of the distortion performance of the amplifier circuit 112 is lowered, the input signal intensity of the undesired signal is decreased by α[db], and the output signal intensity of the intermodulation component does not change. In addition, the desired signal component is amplified and outputted without any problems. Therefore, the SNR does not change. Therefore, the frequency converter circuit 100 of the present embodiment can have low electricity consumption without deteriorating the SNR.

### Second Embodiment

Another embodiment of the present invention is described below referring to drawings. The structure other than what is explained in this present embodiment is the same as the First Embodiment. In addition, as a matter of convenience in explanation, the members with the same function as the members illustrated in the figures of the First Embodiment have the same reference numerals and the explanations of those is omitted here.

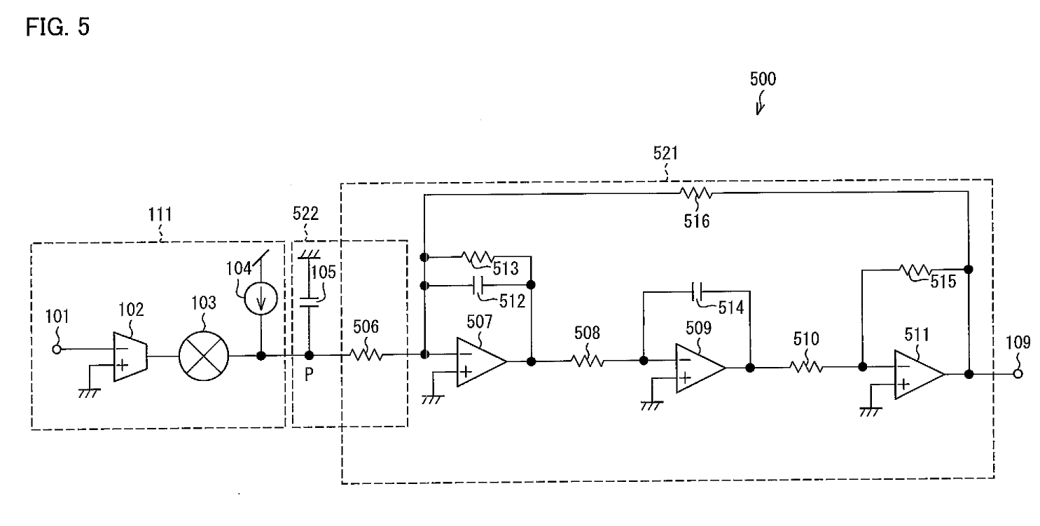

FIG. 5 is a circuit diagram illustrating an exemplary structure of a frequency converter circuit 500.

The frequency converter circuit 500 of the present embodiment includes a frequency conversion section 111, a capacitor 105, a second-order LFP 521, and an output section 109, as illustrated in FIG. 5. In the frequency converter circuit 500, an output section of the frequency conversion section 111 is connected to an input section of the second-order LPF 521. In addition, the capacitor 105 has one terminal connected to a point (point P) on the line connecting the output section of the frequency conversion section 111 and the input section of the second-order LPF 521, and the other terminal being AC-grounded.

The second-order LPF 521 is a second-order low-pass filter of a BIQUAD type, and includes an input resistor 506 (integral resistor), an operational amplifier 507, a resistor 508, an operational amplifier 509, a resistor 510, an operational amplifier 511, a capacitor 512 (integral capacitor), a resistor 513, a capacitor 514, a resistor 515, and a resistor 516. In addition, the input resistor 506, the capacitor 512 and the operational amplifier 507 form an RC integrator.

The input resistor 506 is provided as an input impedance of the second-order LPF 521. The input resistor 506 has one terminal connected to the frequency conversion section 111, and the other terminal connected to the inverting input terminal of the operational amplifier 507. Thus, one terminal of the input resistor 506 is the input section of the second-order LPF 521.

The operational amplifier 507 has the non-inverting input terminal grounded, and the output terminal connected to the inverting input terminal of the operational amplifier 509 via the resistor 508. In addition, the capacitor 512 and the resistor 513 are provided in parallel between the output terminal and the inverting input terminal of the operational amplifier 507, whereby negative feedback is attained.

The operational amplifier 509 has the non-inverting input terminal grounded, and the output terminal connected to the inverting input terminal of the operational amplifier 511 via the resistor 510. In addition, the capacitor 514 is provided in series between the output terminal and the inverting input terminal of the operational amplifier 509, whereby negative feedback is attained.

The operational amplifier 511 has the non-inverting input terminal grounded, and the output terminal connected to the output section 109. In addition, the resistor 515 is provided in series between the output terminal and the inverting input terminal, whereby negative feedback is attained.

In addition, the resistor 516 is provided in series between the output terminal of the operational amplifier 511 and the inverting input terminal of the operational amplifier 507, whereby negative feedback is attained.

Next, the operation of the frequency converter circuit 500 of the present embodiment is described below.

When the radio frequency signal is inputted to the frequency conversion section 111, the frequency conversion section 111 operates as described in the frequency converter circuit 100 of the previous embodiment. Most of the low frequency current signal outputted from the switch 103 is then sent to the following input resistor 506 of the second-order LPF 521.

That is to say, in the frequency converter circuit 500, the input resistor 506 functions as both the load resistor of the frequency conversion section 111 and the input resistor of the second-order LPF 521.

In addition, in the frequency converter circuit 500, a first-order low-pass filter (first-order LPF 522) is formed from the capacitor 105 and the input resistor 506, as illustrated in FIG. 5. Thus, due to the first-order LPF 522, the low frequency current signal outputted from the frequency conversion section 111 receives the disturbance wave attenuation effect of a certain degree. Thus, the input current intensity of the second-order LPF 521 is weakened by a certain value, compared to the input current intensity of the second-order LPF in the case the disturbance wave attenuation effect is not gained. In this state, the low frequency current signal is converted to a low frequency voltage signal at the second-order LPF 521. Finally, the low frequency voltage signal is then outputted from the output section 109.

Here, in order to boost the Out-of-Band OIP3 in a voltage-input-type active filter such as the second-order LPF 521, it is required such that the operational amplifier have sufficient transmission gain in the frequency at which the undesired disturbance signal exists. That is to say, the operational amplifier can only be in a wide band, which leads to the increase in current consumption.

On the other hand, in the frequency converter circuit 500 of the present embodiment, the same fundamentals of the aforementioned disturbance wave attenuation effect of the previous First Embodiment is obtained. That is, the input current intensity in the second-order LPF 521 is weakened by a certain value compared to the input current intensity of the second-order LPF 521 in the case the first-order LPF is not gained because the signal that gained the disturbance wave attenuation effect to a certain value by the first-order LPF 522 is inputted to the second-order LPF 521.

Thus, it is possible to lower the specifications of the Out-of-Band OIP3 required from the second-order LPF 521, thereby making it possible to attain low current consumption, which is required by the operational amplifiers 507, 509 and 511.

In addition, in the frequency converter circuit 500, a third-order LPF is formed from the two poles of the second-order LPF 521 and the one pole of the first-order LPF 522. Therefore, the frequency converter circuit 500 of the present embodiment can attain further better SNR.

In addition, in regards to the in-band gain of the transmission characteristic from the input section 101 to the output section 109 in the frequency converter circuit 500, the DC voltage gain from the input section 101 to the output section 109 is determined by the transconductor 102, the switch 103, and the input resistor 506. In addition, in regards to the frequency characteristic of the transmission characteristic, the frequency characteristic of the second-order LPF 521 is determined by the resistors 508, 513, 515 and 516, and the capacitors 512 and 514 only.

Therefore, it can be said from the above two points that the resistance value of the input resistor 506 does not influence the frequency characteristic. Specifically, the Out-of-Band signal suppression characteristic of the second-order LPF 521 is constant, with no regards to the value of the input impedance.

Thus, the design factor determining the input resistor 506 will be the following two factors:

Factor 1) A noise due to the input resistor 506;
Factor 2) The area of the capacitor 105 determined by the required time constant for the first-order LPF 522 and the input resistor 506.

Therefore, there is such trade-off that the noise characteristic becomes good with the smaller input resistor 506, and the area of the capacitor 105 required by the first-order LPF 522 becomes smaller with the larger input resistor 506.

Thus, the design becomes extremely simple as mentioned above. Consequently, the number of design constraint conditions determining the design parameter (resistance value, capacitance) decreases by one in realizing the desired filter characteristic in the second-order LPF 521. By the decrease in number of the design constraint condition, it is possible to set the design parameter to a minimally required optimum value in accordance with other design parameters, due to the trade-off of the noise and area.

In addition, for example, consider a case where a switch in the resistance and the capacitance is required such that the frequency characteristic is to be changeable according to modes. In this case, the number of selector elements required can be less, since the design of the input resistor 506 is separated off from the frequency characteristics. In addition, it also leads to the decrease in the number of selector switches (reduction in area) or the reduction in distortion due to the switch (linearity improvement).

### Third Embodiment

Another embodiment of the present invention is described below referring to drawings. The structure other than what is explained in the present embodiment is the same as the previous First and Second Embodiments. In addition, as a matter of convenience in explanation, the members with the same function as the members illustrated in the figures of the First and Second Embodiment have the same reference numerals, and the explanations of those is omitted here.

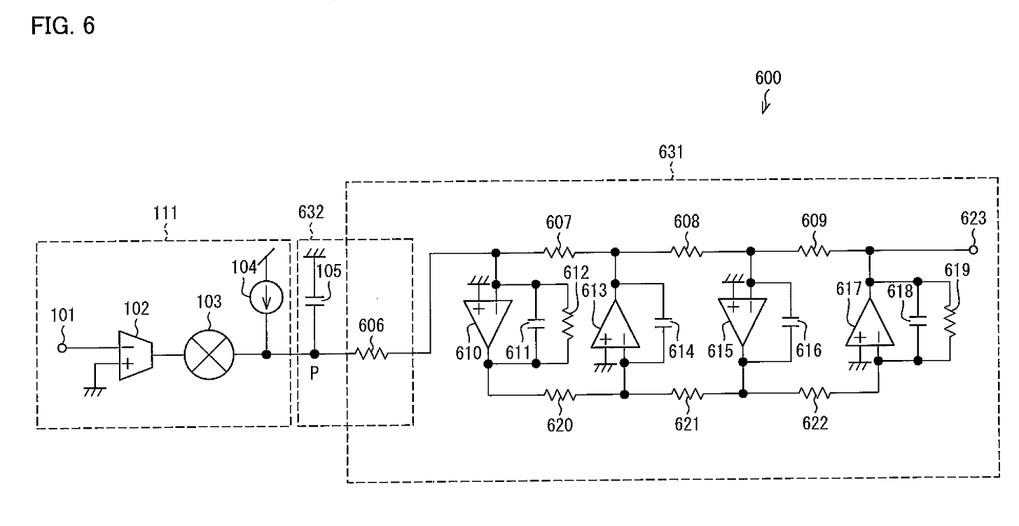

FIG. 6 is a circuit diagram illustrating an exemplary structure of a frequency converter circuit 600.

The frequency converter circuit 600 of the present embodiment includes a frequency conversion section 111, a capacitor 105, and a fourth-order LPF 631, as illustrated in FIG. 6. In the frequency converter circuit 600, an output section of the frequency conversion section 111 is connected to an input section of the fourth-order LPF 631. In addition, the capacitor 105 has one terminal connected to a point (point P) on the line connecting the output section of the frequency conversion section 111 and the input section of the fourth-order LPF 631, and the other terminal being AC-grounded.

The fourth-order LPF 631 is a fourth-order low-pass filter of a LEAPFLOG type, and includes an input resistor 606 (integral resistor), resistors 607 to 609, an operational amplifier 610, a capacitor 611 (integral capacitor), a resistor 612, an operational amplifier 613, a capacitor 614, an operational amplifier 615, a capacitor 616, an operational amplifier 617, a capacitor 618, resistors 619 to 622, and an output section 623. In addition, the input resistor 606, the capacitor 611, and the operational amplifier 610 form an RC integrator.

The input resistor 606 is provided as an input impedance of the fourth-order LPF 631. The input resistor 606 has one terminal connected to the frequency conversion section 111, and the other terminal connected to the inverting input terminal and also one of the resistor 607 terminals. Thus, one of the input resistor 606 terminals is the input section of the fourth-order LPF 631.

The operational amplifier 610 has the non-inverting input terminal grounded, and the output terminal connected to, via the resistor 620, the inverting input terminal of the operational amplifier 613 and also one terminal of the resistor 621. In addition, the capacitor 611 and the resistor 612 are provided in parallel between the output terminal and the inverting input terminal of the operational terminal 610, whereby negative feedback is attained.

The operational amplifier 613 has the non-inverting input terminal grounded, and the output terminal connected to the other terminal of the resistor 607, and also connected to the inverting input terminal of the operational amplifier 615, as well as one of the resistor 609 terminals. The inverting input terminal of the operational amplifier 615 and the terminal of the resistor 609 are connected with the output terminal via the resistor 608. In addition, the capacitor 614 is provided in series between the output terminal and the inverting input terminal of the operational amplifier 613, whereby negative feedback is attained.

The operational amplifier 615 has the non-inverting input terminal grounded, and the output terminal connected to the other terminal of the resistor 621 and also to the inverting input terminal of the operational amplifier 617 via the resistor 622. In addition, the capacitor 616 is provided in series between the output terminal and the inverting input terminal of the operational amplifier 615, whereby negative feedback is attained.

The operational amplifier 617 has the non-inverting input terminal grounded, and the output terminal connected to the other terminal of the resistor 609 and the output section 623. In addition, the capacitor 618 and the resistor 619 are provided in parallel between the output terminal and the inverting input terminal, whereby negative feedback is attained.

Next, the operation of the frequency converter circuit 600 of the present embodiment is described below.

When the radio frequency signal is inputted to the frequency conversion section 111, the frequency conversion section 111 operates as described in the frequency converter circuit 100 of the previous embodiment. Most of the low frequency current signal outputted from the switch 103 is sent to the following input resistor 606 of the fourth-order LPF631.

That is to say, in the frequency converter circuit 600, the input resistor 606 functions as both the load resistor of the frequency conversion section 111 and the input resistor of the fourth-order LPF631.

In addition, in the frequency converter circuit 600, a first-order low-pass filter (first-order LPF 632) is formed from the capacitor 105 and the input resistor 606, as illustrated in FIG. 6. Thus, due to the first-order LPF 632, the low frequency current signal outputted from the frequency conversion section 111 receives the disturbance wave attenuation effect of a certain degree.

Consequently, the same fundamentals of the aforementioned disturbance wave attenuation effect of the First and Second Embodiment is obtained. That is, the input current intensity in the fourth-order LPF 631 is weakened by a certain value compared to the input current intensity of the fourth-order LPF 631 in the case the first-order LPF is not gained because the signal which gained the disturbance wave attenuation effect of a certain value due to the first-order LPF 632 is inputted in the fourth-order LPF 631.

In this state, the low frequent current signal is converted into a low frequency voltage signal by the fourth-order LPF 631. Finally, the low voltage signal is then outputted from the output section 623. Thus, the specification of the Out-of-Band OIP3 required in the fourth-order LPF 631 decreases, thereby making it possible to attain low current consumption, which is required from the operational amplifiers 610, 613, 615 and 617.

In addition, in the frequency converter circuit 600, a fifth-order LPF is formed from the four poles of the fourth-order LPF 631 and the one pole of the first-order LPF 632 combined together. Therefore, the frequency converter circuit 600 of the present embodiment can attain further better SNR.

Here, the frequency converter circuit 600 of the present embodiment has a structure emphasizing the linearity function making it possible to attain further better SNR. The explanation of this is as below.

In the frequency converter circuit 600, as mentioned, the fifth-order LPF is formed. In the structure of this fifth-order LPF, the cutoff frequency of the first-order LPF 632 is arranged in the lowest frequency, and the four complex poles from the fourth-order LPF 631 are to be designed with a relatively high Quality Factor. Thus, the fifth-order LPF is arranged so that the in-band flat characteristic is obtained when combining all five poles.

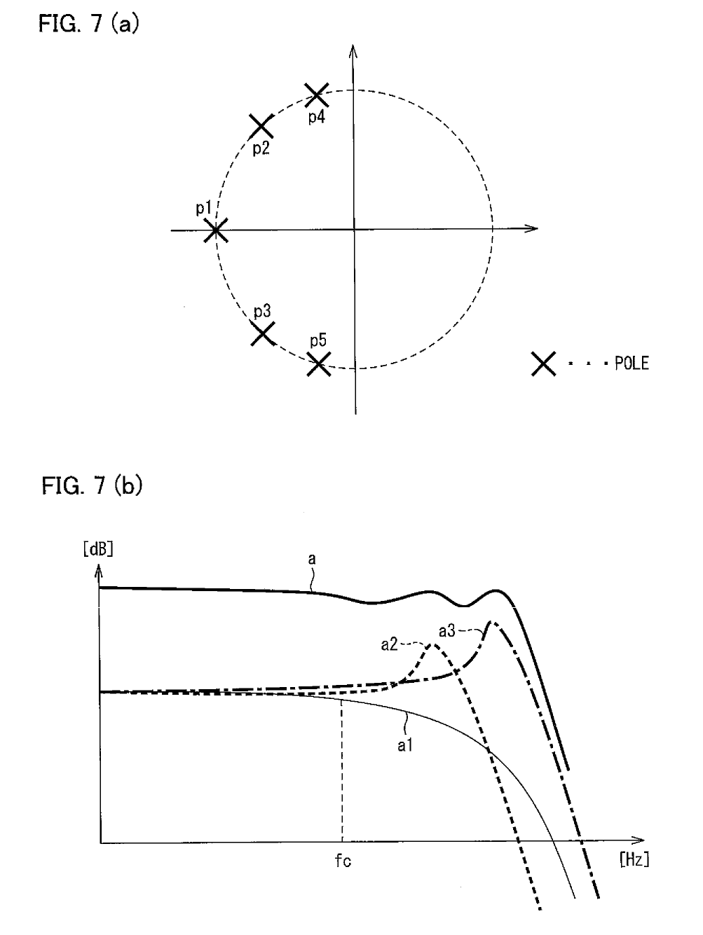

FIG. 7(a) illustrates an example of a pole arrangement of a complex plane in a fifth-order filter, and FIG. 7(b) illustrates characteristics of the fifth-order filter.

When designing the fifth-order filter, it is required to determine the arrangement of the five poles of a transfer function. Consequently, for example, poles p1 to p5 are arranged as illustrated in FIG. 7(a). In the case of this arrangement, the frequency characteristics of the pole p1 is shown by the curved line a1, the frequency characteristics of the pole p2 and p3 are shown by the curved line a2, and the frequency characteristics of the poles p4 and p5 are shown by the curved line a3, as illustrated in FIG. 7(b). In addition, the characteristic of the fifth-order filter is shown by the curved line a combining the curved lines a1 to a3.

In addition, the cutoff frequency fc for the frequency characteristic a1 of the pole p1 is set smaller than the cutoff frequency of the other two frequency characteristics a2 and a3, as illustrated in FIG. 7(b).

In this case, the characteristic of the LPF of the pole p1 is designed in order to realize the first-order LPF 632. That is to say, the lowest frequency is the frequency equivalent to the pole with the smallest cutoff frequency in the required pole arrangement, in order to realize the desired filter characteristics. For example, in the case a filter is designed with the three conditions “cutoff frequency 4 [MHz]”, “Chebyshev characteristic”, and “in-bandpass ripple 0.05[dB]”, the lowest frequency will be 2.81 [MHz].

In addition, at this time, the pole of the first-order LPF 630 becomes inevitably smaller than the desired signal band. Therefore, the signal amplitude inputted to the fourth-order LPF 631, in other words the active filter, becomes significantly small. Consequently, the linear operation area broadens. Thus, it is possible to improve the linearity function in the frequency converter circuit 600 of the present embodiment.

That is to say, by making the cutoff frequency of the first-order LPF 632 smaller than the desired signal band, it is possible to attain great suppression of even the adjacent disturbance wave signal which is hardly suppressed in the conventional structure. Therefore, it is possible to broaden the linear operation area.

In addition, in the frequency converter circuit 600, the low frequency current signals outputted from the frequency conversion section 111 firstly receives the disturbance wave attenuation effect of a certain value due to the first-order LPF 632. Thus, in the case the cutoff frequency of the first-order LPF 632 is smaller than the desired signal band, the desired signal component will be attenuated by a certain amount (β[dB]) and the undesired signal component will also be attenuated by a certain amount (γ[dB](β<γ)).

The attenuation amount (β, γ) is dependent on the frequency in which the disturbance wave signal exists. In order to have a satisfactory noise characteristic for the whole filter, it is better to have the β less, and in order to have a satisfactory disturbance wave elimination characteristic, it is preferable with a larger γ.

The pole arrangement to arrange the cutoff frequency of the first-order LPF 632 as the lowest frequency is also applicable in the frequency converter circuit 500 of the previous embodiment. That is to say, the cutoff frequency of the first-order LPF 522 is to be arranged to the lowest frequency.

### Fourth Embodiment

Another embodiment of the present invention is described below referring to drawings. The structure other than what is explained in the present embodiment is the same as the previous First to Third Embodiments. In addition, as a matter of convenience in explanation, the members with the same function as the members illustrated in the figures of the First to Third Embodiments have the same reference numerals, and the explanations of those is omitted here.

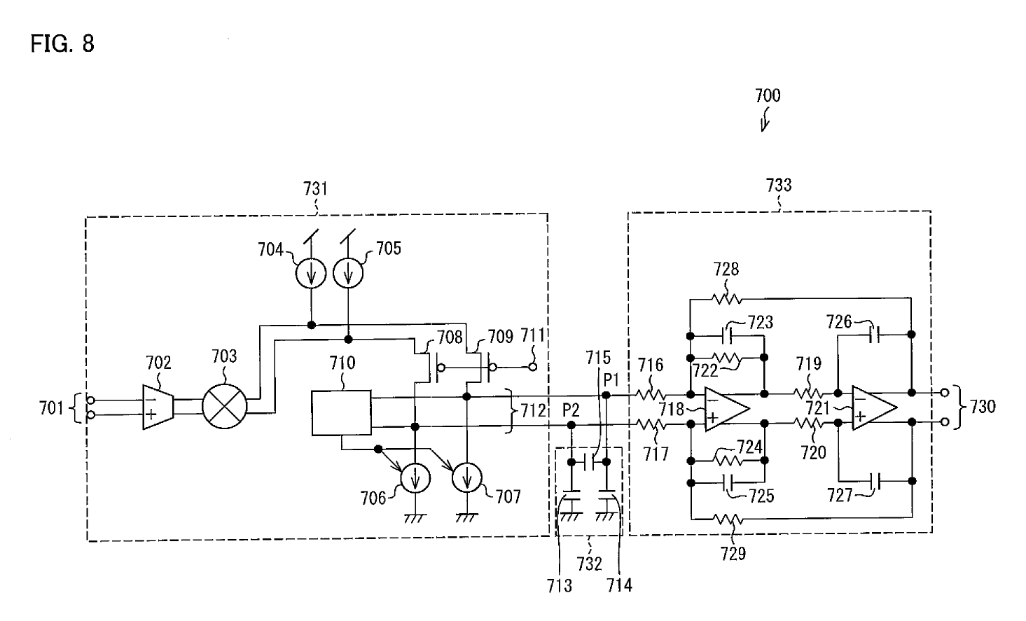

FIG. 8 is a circuit diagram illustrating an exemplary structure of a frequency converter circuit 700.

The frequency converter circuit 700 includes a frequency conversion section 731, a capacitor section 732, a second-order LPF 733, and an output section 730, in which the input and output are of differentials.

The frequency conversion section 731 converts the radio frequency signal inputted as the voltage signal to the low frequency current signal, extracts the low frequency signal by a folded cascode structure and outputs this to the second-order LPF 733. That is to say, the output section of the frequency conversion section 731 is connected to the input section of the second-order LPF 733. The frequency conversion section 731 includes an input section 701, a transconductor 702, a switch 703, current sources 704 to 707, a P channel-type MOSFET (PMOS) 708 and 709, a CMFB circuit 710, and a terminal 711.

The input section 701 has two input terminals. Of the two input terminals, one input terminal is connected to the inverting input terminal of the transconductor 702, and the other input terminal is connected to the non-inverting input terminal of the transconductor 702.

The transconductor 702 is an amplifier that converts the two inputted voltage signals to the current signal by the differential, and converts the radio frequency voltage signal inputted from the input section 701 to the current signal by the differential. The two output terminals of the transconductor 702 are connected to the switch 703.

The switch 703 converts the radio frequency signal inputted by the differential to the low frequency signal. In detail, the switch 703 converts the frequency by inputting a local oscillatory signal together with a radio frequency current signal outputted from the transconductor 102 by the differential, and generates the low frequency signal. The two output terminals of the switch 703 are connected to the PMOS 708 and 709 respectively.

The current sources 704 and 705 have the terminals on the current-supply side, which are connected with the two output terminals of the switch 703 respectively, and the terminals on the opposite side which are connected to the power supply.

The current sources 706 and 707 are provided in order to adjust the output resistance of the frequency conversion 731 so that it is sufficiently greater compared to the input resistor 716 and 717 mentioned later. The current sources 706 and 707 have grounded terminals on the current-supply side, and the other terminals connected to the PMOS 708 and 709 respectively.

The gating terminals of each PMOS 708 and 709 are connected to the terminal 711. Thus, the current flows between the drain and source in accordance with the control signal from the terminal 711.

The CMFB circuit 710 has the two differential terminals 712 connected to the second-order LPF 733, via a point on the line between the PMOS 708 and the current source 706 and a point on the line between the PMOS 709 and the current source 707, respectively. Thus, the two differential terminals 712 of the CMFB circuit 710 are the output sections of the frequency conversion section 731. In addition, the CMFB circuit 710 provides a CMFB control signal to the current sources 706 and 707 by detecting the common mode electric potential of the differential terminal 712, so that the electric potential is stably constant.

The capacitor 732 includes the capacitors 713 to 715, which are shunt capacitors.

The capacitor 713 (first shunt capacitor) has one terminal connected to a point on the line connecting the output section of the frequency conversion section 731 and the input section of the second-order LPF 733 (point P2), and the other terminal AC-grounded. The capacitor 714 (first shunt capacitor) has one terminal connected to a point on the line connecting the output section of the frequency conversion section 731 and the input section of the second-order LPF 733 (point P1), and the other terminal AC-grounded. The capacitor 715 (second shunt capacitor) has one terminal connected to a terminal on the connecting side of the point P2 of the capacitor 713, and the other terminal connected to the terminal on the connecting side of the point P1 of the capacitor 714.

The second-order LPF 733 is a second-order low-pass filter of a BIQUAD type, and includes an input resistor 716 and 717, an operational amplifier 718, resistors 719 and 720, an operational amplifier 721, a resistor 722, a capacitor 723, a resistor 724, capacitors 725 to 727, and resistors 728 and 729.

The input resistors 716 and 717 are provided as the input impedance of the second-order LPF 733. The input resistor 716 has one terminal connected to the frequency conversion section 731, and the other terminal connected to the inverting input terminal of the operational amplifier 718. The input resistor 717 has one terminal connected to the frequency conversion section 731, and the other terminal connected to the non-inverting input terminal of operational amplifier 718. Thus, one of the terminals of the input resistor 716 and one of the terminals of the input resistor 717 are the input section of the second-order LPF 733.

The operational amplifier 718 has a first output terminal connected to the inverting input terminal of the operational amplifier 721 via the resistor 719, and a second output terminal connected to the non-inverting input terminal of the operational amplifier 721 via the resistor 720. In addition, the resistor 722 and the capacitor 723 are provided in parallel between the first output terminal and the inverting input terminal, whereby negative feedback is attained. Furthermore, the resistor 724 and the capacitor 725 are provided in parallel between the second output terminal and the non-inverting input terminal, whereby negative feedback is attained.

The operational amplifier 721 has a first output terminal and a second output terminal connected to the output section 730, respectively. In addition, the capacitor 726 is provided in series between the first output terminal and the inverting input terminal, whereby negative feedback is attained. Furthermore, the capacitor 727 is provided in series between the second output terminal and the non-inverting input terminal, whereby negative feedback is attained.

In addition, the resistor 728 is provided in series between the first output terminal of the operational amplifier 721 and the inverting input terminal of the operational amplifier 718, whereby negative feedback is attained. Furthermore, the resistance 729 is provided in series between the second output terminal of the operational amplifier 721 and the non-inverting input terminal of the operational amplifier 718, whereby negative feedback is attained.

Next, the operation of the frequency converter circuit 700 of the present embodiment is described below.

When the radio frequency signal is inputted to the frequency conversion section 731, the transconductor 702 and the switch 703 operates as the aforementioned transconductor 102 and switch 103 in the frequency converter circuit 100 of the previous embodiment, except for the difference such that the input and output are differential respectively.

The same current as the output current from the switch 703 which output current has been subjected to the frequency conversion is flowed from the current sources 704 and 705 to the differential terminal 712, via the cascoded PMOS 708 and 709, respectively.

The output current of the frequency conversion section 731 is converted from current to voltage while being first-order filtered, by the first-order LPF which attenuates the disturbance waves of a certain value including the capacitor 732 and the input resistors 716 and 717 of the second-order LPF 733.

At the same time, the signal which is voltage-converted by the first-order LPF is further filtered secondly by the second-order LPF 733, and only the desired signal is extracted from the output section 730. Thus, the specification of the Out-of-Band OIP3 required by the second-order LPF 733 lowers, which makes it possible to attain low current consumption required from the operational amplifier 718 and 721.

In addition, the frequency converter circuit 700 has a third-order LPF formed from the two poles of the second-order LPF and the one pole of the first-order LPF, therefore it is possible to obtain the third-order LPF characteristic as a whole. Therefore, the frequency converter circuit 700 of the present embodiment can attain further better SNR.

In addition, the current value of the current sources 706 and 707 vary depending on the CMFB control signal. Here, the common mode electric potential (DC bias voltage) of the differential terminal 712 is designable arbitrarily, and can be designed such that the maximum voltage amplitude range may be acquired from this terminal. Thus, it is possible to suppress the distortion of the signal in the differential terminal 712 at the minimum.

Here, in general, the capacitor is realizable as a capacitance of effectively 4 times larger, by inserting the capacitor between the differential terminal. Thus, inserting the capacitor between the differential terminal is effective in reducing the area. However, if considering that the differential terminal 712 is the current output terminal of the frequency conversion section 731, there is a high possibility that a common-mode component of the radio frequency exists. Therefore, the tolerance towards common-mode noise is also increased by locating not all of the required capacitance by the first-order LPF between the differential and grounding a part of the required capacitance.

### Fifth Embodiment

Another embodiment of the present invention is described below referring to drawings. The structure other than what is explained in the present embodiment is the same as the previous First to Fourth Embodiments. In addition, as a matter of convenience in explanation, the members with the same function as the members illustrated in the figures of the First to Fourth Embodiments will have the same reference numerals, and the explanations of those is omitted here.

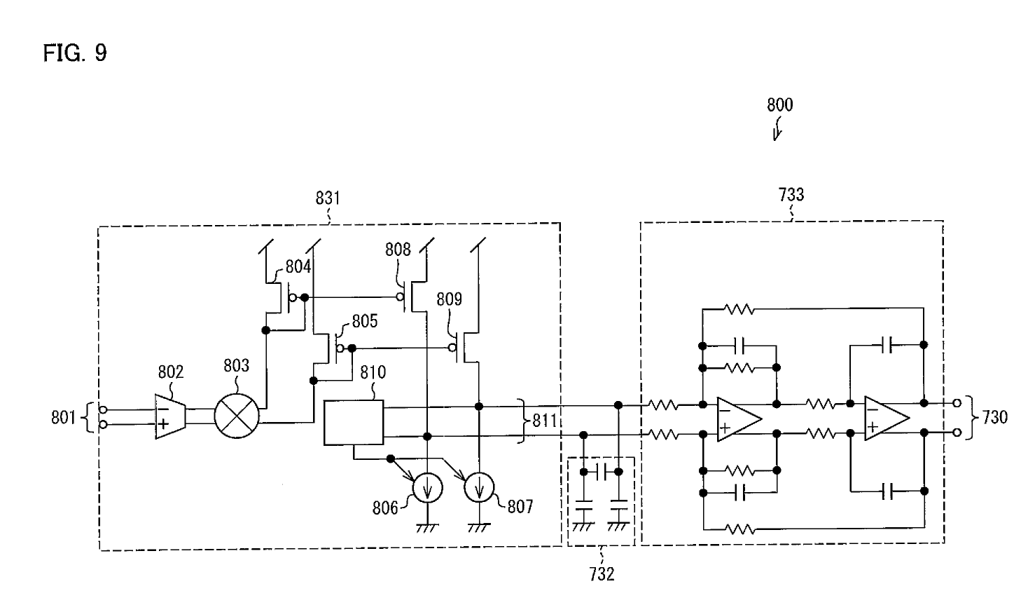

FIG. 9 is a circuit diagram illustrating an exemplary structure of a frequency converter circuit 800.

The frequency converter circuit 800 of the present embodiment includes a frequency conversion section 831, a capacitor section 732, a second-order LPF 733, and an output section 730, in which the input and output are of differentials. That is to say, the frequency converter circuit 800 of the present embodiment has the same structure of the frequency converter circuit 700, however replacing the frequency conversion section 731 with the frequency conversion section 831.

The frequency conversion section 831 converts the radio frequency signal inputted as the voltage signal to the low frequency current signal, extracts the low frequency signal by a current mirror structure, and outputs this to the second-order LPF 733. That is to say, the output section of the frequency conversion section 831 is connected to the input section of the second-order LPF 733. The frequency conversion section 831 includes an input section 801, a transconductor 802, a switch 803, PMOSs 804 and 805, current sources 806 and 807, PMOSs 808 and 809, and a CMFB circuit 810.

The input section 801, the transconductor 802 and the switch 803 have the same configuration as the input section 701, the transconductor 702 and the switch 703 of the frequency converter circuit 700 of the previous Fourth Embodiment. However, the two output terminals of the switch 803 are connected to the PMOSs 804 and 805 respectively.

The PMOS 804 constitutes the current mirror circuit with the PMOS 808. PMOS 805 constitutes the current mirror circuit with the PMOS 809. In addition, the PMOSs 804, 805, 808, and 809 are connected to the power supply respectively.

The current sources 806 and 807 are provided to adjust the output resistance of the frequency conversion section 831 so that it is sufficiently greater compared to the input resistors 716 and 717. The current sources 806 and 807 have the terminals on the current-supply side grounded respectively, and the terminals on the opposite side thereof connected to the PMOS 808 and 809 respectively.

The CMFB circuit 810 has the two differential terminals 811 connected to the second-order LPF 733, via a point on the line between the PMOS 808 and the current source 806, and a point on the line between the PMOS 809 and the current source 807, respectively. Therefore, the two differential terminals 811 of the CMFB circuit 810 are the output sections of the frequency conversion section 831. In addition, the CMFB circuit 810 provides the CMFB control signal to the current sources 806 and 807 by detecting the common-mode electric potential of the differential terminal 811, so that the electric potential is stably constant.

Next, the operation of the frequency converter circuit 800 of the present embodiment is described below.

When the radio frequency signal is inputted to the frequency conversion section 831, the transconductor 802 and the switch 803 operates as the aforementioned transconductor 102 and switch 103 in the frequency converter circuit 100 of the previous embodiment, except for the difference such that the input and output are differential respectively.

The output current from the switch 803 which output current has been subjected to the frequency conversion is flowed to the PMOS 804 and 805, respectively. The same current as the current flowing to the PMOS 804 flows to the PMOS 808, and the same current as the current flowing to the PMOS 805 flows to the PMOS 809. This is because (i) the PMOS 804 and the PMOS 808 constitute a current mirror circuit and (ii) the PMOS 805 and the PMOS 809 constitute a current mirror circuit. The currents are then outputted to the differential terminal 811 respectively.

Here, the current value of the current sources 806 and 807 vary depending on the CMFB control signal. The common-mode electric potential (DC bias voltage) of the differential terminal 811 is designable arbitrarily, and can be designed such that the maximum voltage amplitude range of the terminal can be acquired. Thus, it is possible to suppress the distortion of the signal in the differential terminal 811 at the minimum.

In addition, the operation effect of the second-order LPF 733 and the capacitor section 732 is as mentioned in the frequency converter circuit 700 of the Fourth Embodiment.

As it is obvious by referring to FIG. 9 looking at the PMOS 804, 805, 808 and 809 being connected to the differential terminals 811, the two transistors is connected serially. Thus, the voltage amplitude range is broad in the differential terminals 811 compared to the differential terminal 712 in the frequency converter circuit 700 of the Fourth Embodiment. Therefore, it is possible to further improve the linearity of the second-order LPF 733.

### Sixth Embodiment

Another embodiment of the present invention is described below referring to drawings. The structure other than what is explained in the present embodiment is the same as the previous First to Fifth Embodiments. In addition, as a matter of convenience in explanation, the members with the same function as the members illustrated in the figures of the First to Fifth Embodiments have the same reference numerals, and the explanations of those is omitted here.

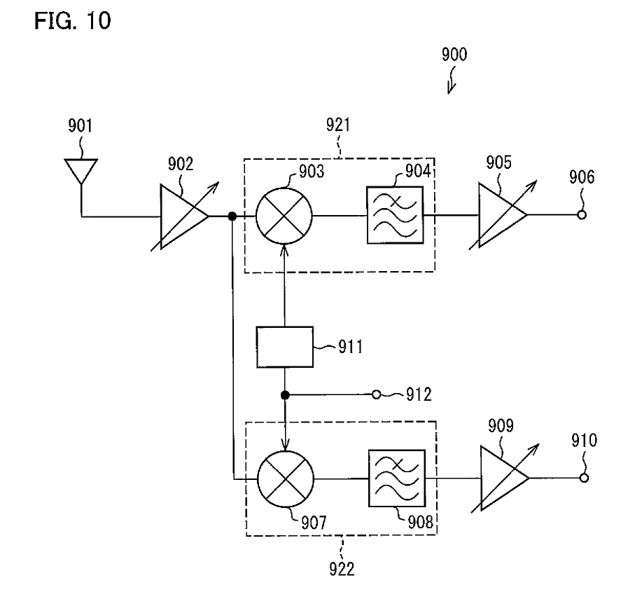

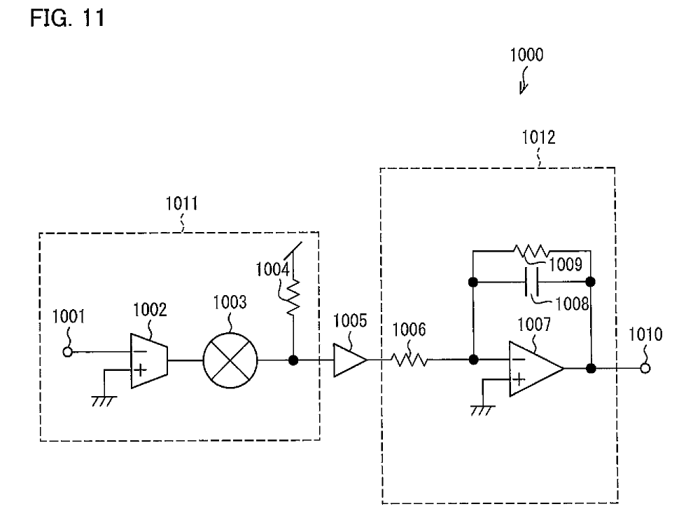

FIG. 10 is a circuit diagram illustrating an exemplary structure of a direct conversion receiver 900.

The direct conversion receiver 900 of the present embodiment (receiver) is a receiver performing the conversion of the frequency in the direct conversion system, and includes an antenna 901, an LNA 902, a frequency conversion section 903, a filter 904, a VGA 905, an output section 906, a frequency conversion section 907, a filter 908, a VGA 909, an output section 910, a phase shifter 911, and a terminal 912, as illustrated in FIG. 10. Other structures of the direct conversion receiver 900 not illustrated are to be a generally operable structure.

In addition, the frequency conversion section 903 and the filter 904 constitute an I-channel section 921. The frequency conversion section 907 and the filter 908 constitute a Q-channel section.

When the radio frequency signal is received by the antenna 901, the signal is outputted to the frequency conversion section 903 and the frequency conversion section 907, after it is amplified by the LNA 902. At the frequency conversion section 903 and the frequency conversion section 907, the inputted signal is down converted to a DC signal.

In detail, an LO signal equal to the central frequency of the radio frequency wireless signal is inputted from the terminal 912, and a signal of two systems with the phase displaced by 90 degrees is generated by the phase shifter 911. The signal of two systems is supplied into the I-channel section 921 and the Q-channel section 922 respectively due to the mixing effect in the frequency conversion section 903 and 907. In the frequency conversion section 903 and the frequency conversion section 907, the radio frequency signal outputted from the LNA 902 is down converted based on the signal outputted from the phase shifter 911.

Then, the undesired signals are removed from the signal outputted from the frequency conversion section 903 by the filter 904, and is converted to a baseband signal of an appropriate signal level for the following circuit, at the VGA 905. This signal is then outputted to the following circuit from the output section 906.

In addition, the undesired signals are removed from the signal outputted from the frequency conversion section 907 by the filter 908, and is converted to a baseband signal of an appropriate signal level for the following circuit, at the VGA 909. This signal is then outputted to the following circuit from the output section 910.

Here, the frequency conversion section 903 and 907, and the filter 904 and 908 may have any of the structures described in the First to Fifth Embodiments. With any of the structure, it is possible to attain low current consumption at the I-channel 921 and the Q-channel 922.

Therefore, the direct conversion receiver 900 of the present embodiment can extract the desired signal including the low frequency data while suppressing the influence of the signal distortion that would be caused by the important undesired disturbance waves. Further, this structure attains low current consumption.

The present invention is not limited to the description of the embodiments above, but may be altered by a skilled person within the scope of the claims. An embodiment based on a proper combination of technical means disclosed in different embodiments is encompassed in the technical scope of the present invention.

The present invention is applicable to, for example, frequency converter circuits installed in a receiver performing the conversion of frequency in the direct conversion system or the LOW-IF system. However the present invention is not limited to this, and is also applicable to other fields.

As above, the frequency converter circuit of the present invention includes a frequency conversion section for converting an inputted radio frequency signal to a low frequency current signal and outputting the low frequency current signal from an output section thereof, a voltage-input-type amplifier circuit with an input section being connected to the output section of the frequency conversion section and having an input impedance, and a first shunt capacitor with one terminal connected to an input section of the voltage-input-type amplifier circuit and the other terminal AC-grounded.

Thus, the undesired radio frequency signal included in the low frequency current signal outputted from the output section of the frequency conversion section is attenuated by the first-order low-pass filter including the input impedance of the voltage-input-type amplifier circuit and the first shunt capacitor. Accordingly, it is possible to lower the specification of the distortion performance (for example, the Out-of-Band IP3 or the like) required in the following voltage-input-type amplifier circuit. Consequently, by lowering the specification of the distortion performance of the voltage-input-type amplifier circuit, it is possible to reduce the electricity consumption.

In addition, in the voltage-input-type amplifier circuit, even if the specification of the voltage-input-type amplifier circuit is lowered, the undesired radio frequency signal is attenuated. Therefore, the output signal intensity of the intermodulation component does not change. Thus, the SNR does not deteriorate. Therefore, it is possible for the frequency converter circuit of the present invention to reduce the electricity consumption without deteriorating the SNR.

In addition, the frequency converter circuit of the present invention is preferably arranged such that the voltage-input-type amplifier circuit is a voltage-input-type active filter.

With the structure, since the specification of the distortion performance of the voltage-input-type active filter is suppressed low, the required performance of the amplifying element used for the voltage-input-type active filter (for example, the operational amplifier or the transconductor) also decreases, which makes it possible to attain low electrical consumption.

In addition, the frequency converter circuit of the present invention is preferably arranged such that the cutoff frequency of the first-order low-pass filter composed of the input impedance of the voltage-input-type active filter and the capacitance of the first shunt capacitor is smaller than the signal band of a desired signal in the low frequency current signal, the desired signal including the data.

With the structure, strong level suppressing is possible even for the adjacent disturbance wave signals, which mostly are not suppressed in the conventional structure. In addition, it is possible to further suppress the specification of the distortion performance of the voltage-input-type active filter even lower, and is possible to further reduce the electricity consumption.

As the input impedance, the following structure is possible.

The input impedance is preferably provided by an input resistor with one terminal connected to the input section, and the other terminal connected to a following structure in the voltage-input-type active filter.

In addition, the frequency converter circuit of the present invention is preferably arranged such that the voltage-input-type active filter has a structure of a BIQUAD type including an RC integrator as a first stage.

With the structure, the Out-of-Band signal suppression characteristic of the voltage-input-type active filter is constant, with no regards to the value of the input impedance. Thus, it is possible to set the value of the input impedance to a minimum required value depending on the other design parameters (for example, noise, linearity or the like). For example, it is possible to make the area of the first shunt capacitor required by the first-order low-pass filter small, by increasing the value of the input impedance.

In addition, the frequency converter circuit of the present invention is preferably arranged such that the voltage-input-type active filter has a structure of a LEAPFLOG type including an RC integrator as a first stage.

With the structure, the Out-of-Band signal suppression characteristic of the voltage-input-type active filter is constant, with no regards to the value of the input impedance. Thus, it is possible to set the value of the input impedance to a minimum required value depending on the other design parameters (for example, noise, linearity or the like). For example, it is possible to make the area of the first shunt capacitor required by the first-order low-pass filter small, by increasing the value of the input impedance.

As the RC integrator, the following structure is possible.

The RC integrator is preferably including an operational amplifier with an inverting input terminal connected to the input section via the integral resistor, a non-inverting input terminal grounded, and an output terminal connected to a following stage in the voltage-input-type active filter, and an integral capacitor connected between the output terminal and the inverting input terminal such that negative feedback is attained.

In addition, the frequency converter circuit of the present invention is preferably arranged such that the frequency conversion section extracts the low frequency current signal from a folded cascode structure.

With the structure, it is possible to freely design the DC bias voltage of the output section of the frequency conversion section and obtain a broad voltage amplitude width. Thus, it is possible to suppress the signal distortion in the output section at the minimum.

In addition, the frequency converter circuit of the present invention is preferably arranged such that the frequency conversion section extracts the low frequency current signal from a current mirror structure.

With the structure, it is possible to freely design the DC bias voltage of the output section of the frequency conversion section and obtain a broad voltage amplitude width. Thus, it is possible to suppress the signal distortion in the output section at the minimum.

In addition, the frequency converter circuit of the present invention is preferably arranged such that the frequency conversion section has a differential input and output structure comprising two output sections, the voltage-input-type amplifier circuit has a differential input and output structure comprising two input sections, the input sections are connected with the output sections respectively so that they are paired with the output sections respectively, and the frequency converter circuit further comprising a second shunt capacitor provided between the two input sections.

According to the structure, of the required capacitance in order to realize the desired cutoff frequency, the area of the second shunt capacitor provided between the input sections which performs differentiation halves in size. Therefore, it is possible to downsize the circuit area.

In addition, the receiver of the present invention comprises the aforementioned frequency converter circuit as the frequency converter circuit for converting a frequency of the received radio frequency signal and extracting a desired signal including a low frequency data.

Thus, for example, in the direct conversion system or the LOW-IF system, it is possible to extract the desired signal including the low frequency data while suppressing the influence of the signal distortion that would be caused by the important undesired disturbance waves. Further, this structure attains low current consumption.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A frequency converter circuit comprising:
a frequency conversion section for converting an inputted radio frequency signal to a low frequency current signal, and outputting the low frequency current signal from an output section thereof;
a voltage-input-type amplifier circuit comprising an input section being connected to the output section of the frequency conversion section, and having an input impedance; and
a first shunt capacitor wherein one terminal is connected to an input section of the voltage-input-type amplifier circuit, and the other terminal is AC-grounded.

2. The frequency converter circuit as set forth in claim 1, wherein the voltage-input-type amplifier circuit is a voltage-input-type active filter.

3. The frequency converter circuit as set forth in claim 2, wherein a cutoff frequency of a first-order low-pass filter composed of the input impedance of the voltage-input-type active filter and the capacitance of the first shunt capacitor is smaller than a signal band of a desired signal in the low frequency current signal, the desired signal including data.

4. The frequency converter circuit as set forth in claim 2, wherein the voltage-input-type active filter has a structure of a BIQUAD type including an RC integrator as a first stage.

5. The frequency converter circuit as set forth in claim 4, wherein the RC integrator comprises:
an operational amplifier with an inverting input terminal connected to the input section via the integral resistor, a non-inverting input terminal grounded, and an output terminal connected to a following stage in the voltage-input-type active filter; and
an integral capacitor connected between the output terminal and the inverting input terminal such that negative feedback is attained.

6. The frequency converter circuit as set forth in claim 2, wherein the voltage-input-type active filter has a structure of a LEAPFLOG type including an RC integrator as a first stage.

7. The frequency converter circuit as set forth in claim 6, wherein the RC integrator comprises:
an operational amplifier with an inverting input terminal connected to the input section via the integral resistor, a non-inverting input terminal grounded, and an output terminal connected to a following stage in the voltage-input-type active filter; and
an integral capacitor connected between the output terminal and the inverting input terminal such that negative feedback is attained.

8. The frequency converter circuit as set forth in claim 3, wherein the input impedance is provided by an input resistor with one terminal connected to the input section, and the other terminal connected to a following structure in the voltage-input-type active filter.

9. The frequency converter circuit as set forth in claim 3, wherein the voltage-input-type active filter has a structure of a BIQUAD type including an RC integrator as a first stage.

10. The frequency converter circuit as set forth in claim 9, wherein the RC integrator comprises:
an operational amplifier with an inverting input terminal connected to the input section via the integral resistor, a non-inverting input terminal grounded, and an output terminal connected to a following stage in the voltage-input-type active filter; and
an integral capacitor connected between the output terminal and the inverting input terminal such that negative feedback is attained.

11. The frequency converter circuit as set forth in claim 3, wherein the voltage-input-type active filter has a structure of a LEAPFLOG type including an RC integrator as a first stage.

12. The frequency converter circuit as set forth in claim 11, wherein the RC integrator comprises:
an operational amplifier with an inverting input terminal connected to the input section via an integral resistor, a non-inverting input terminal grounded, and an output terminal connected to the following stage in the voltage-input-type active filter; and
an integral capacitor connected between the output terminal and the inverting input terminal such that negative feedback is attained.

13. The frequency converter circuit as set forth in claim 1, wherein the frequency conversion extracts the low frequency current signal by a folded cascode structure.

14. The frequency converter circuit as set forth in claim 1, wherein the frequency conversion section extracts the low frequency current signal by a current mirror structure.

15. The frequency converter circuit as set forth in claim 1, wherein:
the frequency conversion section has a differential input and output structure comprising two output sections;
the voltage-input-type amplifier circuit has a differential input and output structure comprising two input sections;
the input sections are connected with the output sections respectively so that they are paired with the output sections respectively; and
the frequency converter circuit further comprises a second shunt capacitor provided between the two input sections.

16. A receiver comprising:
a frequency converter circuit for converting a frequency of a received radio frequency signal and extracting a desired signal including a low frequency data, the frequency converter circuit comprising:
a frequency conversion section for converting an inputted radio frequency signal to a low frequency current signal, and outputting the low frequency current signal from an output section thereof;
a voltage-input-type amplifier circuit comprising an input section being connected to the output section of the frequency conversion section, and having an input impedance; and
a first shunt capacitor wherein one terminal is connected to an input section of the voltage-input-type amplifier, and the other terminal is AC-grounded.
